(19) United States
(12) Patent Application Publication
(10) Pub. No.: US 2026/0099748 A1
(43) Pub. Date: Apr. 9, 2026

(54) QUANTUM FOURIER TRANSFORM (QFT) PARTITIONING AND TIMING IN A DATACENTER

(71) Applicant: Cisco Technology, Inc., San Jose, CA (US)

(72) Inventors: Eneet Kaur, Somerville, MA (US); Reza Nejabati, Los Angeles, CA (US)

(21) Appl. No.: 18/928,295

(22) Filed: Oct. 28, 2024

Related U.S. Application Data
(60) Provisional application No. 63/673,982, filed on Jul. 22, 2024.

(51) Int. Cl. G06N 10/40

(52) U.S. Cl. CPC G06N 10/40

(57) ABSTRACT

An example embodiment provides a technique for a distributed quantum Fourier transform (QFT) with reduced EPR pairs. The QFT may be run in a quantum datacenter between multiple data units, where embodiments run the QFT while using multiple resources. The technique implements a QFT(n) (a QFT with n qubits) on two quantum processors, and is extended to implement the QFT(n) on three or more quantum processors. At the culmination of the technique, the qubits are properly positioned (in reverse order) among the quantum processors to obviate swapping of the qubits at completion of the QFT circuit. The technique relies on teleportation of the qubits.

### CROSS-REFERENCE TO RELATED APPLICATION

This application claims priority to U.S. Provisional Patent Application Serial No. 63/673,982, entitled “Quantum Fourier Transform (QFT) Partitioning and Timing in a Datacenter” and filed on July 22, 2024, the entirety of which is incorporated herein by reference.

### TECHNICAL FIELD

The present disclosure relates to quantum computing.

### BACKGROUND

A quantum Fourier transform (QFT) is a cornerstone of many quantum algorithms and plays a crucial role in a speedup that quantum computers can achieve over classical counterparts. For example, the QFT is a key component of Shor’s algorithm, which is used for factoring large integers and has significant implications for cryptography. In addition, the QFT is employed in quantum phase estimation algorithms which are foundational for applications in quantum chemistry, optimization, and solving linear systems of equations.

An approach for a distributed QFT for two partitions calculates the number of required Einstein–Podolsky–Rosen (EPR) pairs to be n/2 for a QFT(n), where n refers to the number of qubits in the circuit and without considering the swapping of qubits back into original position. The swapping of qubits is relegated to bookkeeping. If we consider the cost of moving the qubits to the final position, then the required cost of EPR pairs is n + n/2 = 3n/2. The approach uses the concept of grouping multiple two-qubit gates and one EPR pair to implement this group of gates (referred to as a cat-entangler and cat-disentangler). However, cat-entangled states consume significant resources and also require more error correction since maintaining the coherence in two qubits at the same time is needed. Another approach is to use gate teleportation to implement the non-local gates. This also utilizes a significant number of EPR pairs.

### BRIEF DESCRIPTION OF THE DRAWINGS

FIG. 1 is a block diagram of an example quantum network environment in which a distributed quantum Fourier transform (QFT) circuit may be implemented, according to an example embodiment.

FIG. 2 illustrates an example QFT circuit.

FIG. 3A illustrates a method for partitioning and executing a QFT circuit among two quantum processors, according to an example embodiment.

FIG. 3B illustrates example pseudocode corresponding to the method of FIG. 3A, according to an example embodiment.

FIG. 4 illustrates an example of partitioning and executing an example QFT circuit among two quantum processors, according to an example embodiment.

FIG. 5A illustrates a method for partitioning a QFT circuit among three or more quantum processors, according to an example embodiment.

FIG. 5B illustrates example pseudocode corresponding to the method of FIG. 5A, according to an example embodiment

FIGS. 6A - 6B illustrate an example of partitioning and executing an example QFT circuit among four quantum processors, according to an example embodiment.

FIG. 7 illustrates a flowchart of a generalized method for partitioning and executing a QFT circuit for distributed quantum processing, according to an example embodiment.

FIG. 8 illustrates a hardware block diagram of a computing device configured to perform functions associated with operations discussed herein, according to an example embodiment.

### DETAILED DESCRIPTION

### Overview

Provided herein are techniques for a distributed quantum Fourier transform (QFT) with reduced EPR pairs that rely on teleportation of the qubits. The QFT may be run in a quantum datacenter between multiple data units, where embodiments run the QFT while using multiple resources. A QFT(n) (a QFT with n qubits) is implemented on two quantum processors, and is extended to implement the QFT(n) on three or more quantum processors. At the culmination, the qubits are properly positioned (in reverse order) among the quantum processors to obviate swapping of the qubits at completion of the QFT circuit.

### Example Embodiments

Example embodiments implement a distributed quantum Fourier transform (QFT) with reduced EPR pairs. The QFT may be run in a quantum datacenter between multiple data units, where embodiments run the QFT while using multiple resources. An embodiment uses a technique to implement a QFT(n) (a QFT with n qubits) on two quantum processors, and the technique is extended to implement the QFT(n) on three or more quantum processors. At the culmination of the technique, the qubits are properly positioned (in reverse order) among the quantum processors to obviate swapping of the qubits at completion of the QFT circuit. The technique relies on teleportation of the qubits.

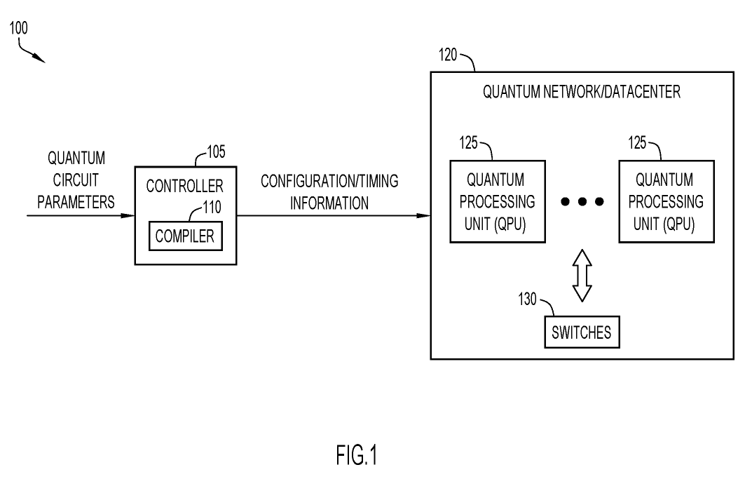

FIG. 1 is a block diagram of an example quantum network environment 100 in which partitioning and executing a QFT circuit may be implemented. Quantum network environment 100 includes a controller 105 and a quantum network or datacenter 120. Controller 105 may be included within, or remote from, quantum datacenter 120. The quantum datacenter includes a series of quantum nodes or processors (e.g., quantum processing units (QPUs) 125) and one or more switches 130 enabling generation of EPR pairs for, and connectivity between, QPUs 125. Controller 105 receives parameters for a quantum algorithm or circuit (e.g., QFT, etc.), and includes a compiler 110 that processes the parameters to produce configuration and timing information for QPUs 125 to enable distributed performance of the quantum algorithm or circuit (e.g., QFT, etc.) on QPUs 125. Compiler 110 may employ the techniques of example embodiments described herein to produce the configuration and timing information. Quantum network or datacenter 120 is configured (e.g., via controller 105, etc.) based on the configuration and timing information to perform the quantum algorithm or circuit in a distributed fashion. For example, the configuration and timing information may include qubit allocation to QPUs 125 in the quantum network or datacenter at any given time, EPR requirement between the QPUs which provides the configuration of switches 130, and the actions to perform on the EPR pairs (e.g., qubit teleportation, etc.).

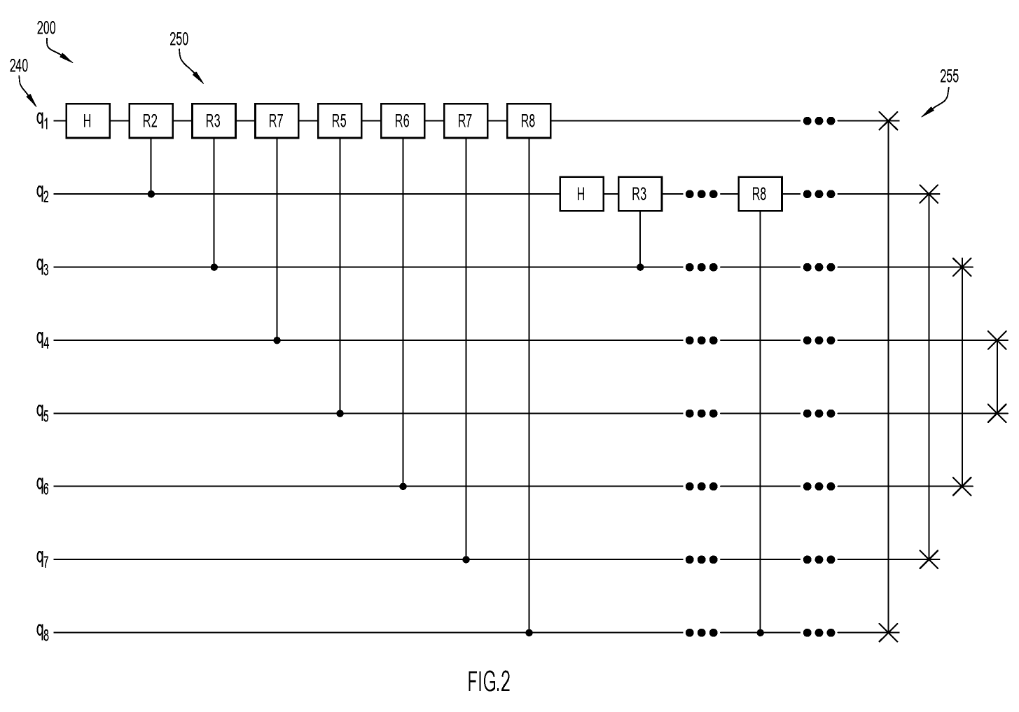

With continued reference to FIG. 1, FIG. 2 illustrates an example QFT circuit 200. QFT circuit 200 includes quantum gates 250 that are applied to (or performed or executed on) a series of qubits 240 (e.g., qubits q₁ to q₈ as viewed in FIG. 2). The quantum gates include a Hadamard gate (H as viewed in FIG. 2) and one or more controlled rotation gates (e.g., R2, R3, R4, R5, R6, R7, and R8 as viewed in FIG. 2). Each controlled rotation gate operates on a target qubit based on a control qubit. For example, controlled rotation gate R2 utilizes qubit q₂ as the control qubit, controlled rotation gate R3 utilizes qubit q₃ as the control qubit, controlled rotation gate R4 utilizes qubit q₄ as the control qubit, controlled rotation gate R5 utilizes qubit q₅ as the control qubit, controlled rotation gate R6 utilizes qubit q₆ as the control qubit, controlled rotation gate R7 utilizes qubit q₇ as the control qubit, and controlled rotation gate R8 utilizes qubit q₈ as the control qubit.

QFT circuit 200 has a format that includes, for all i in [1, n], apply a Hadamard gate (H) on the i-th qubit followed by controlled rotations with the i-th qubit as the target qubit and a j-th qubit as the control qubit (where n represents the number of qubits in the QFT circuit and j > i). Qubits i and n – i +1 are swapped. By way of example, QFT circuit 200 includes eight qubits (e.g., qubits q₁ to q₈ as viewed in FIG. 2). A Hadamard (H) gate is applied to qubit q₁, and the result is serially applied through a chain of controlled rotation gates R2 – R8 with each gate utilizing the corresponding control qubit as described above. A Hadamard (H) gate is applied to qubit q₂, and the result is serially applied through a chain of controlled rotation gates R3 – R8 with each gate utilizing the corresponding control qubit as described above. A Hadamard (H) gate is applied to qubit q₃, and the result is serially applied through a chain of controlled rotation gates R4 – R8 with each gate utilizing the corresponding control qubit as described above. A Hadamard (H) gate is applied to qubit q₄, and the result is serially applied through a chain of controlled rotation gates R5 – R8 with each gate utilizing the corresponding control qubit as described above. A Hadamard (H) gate is applied to qubit q₅, and the result is serially applied through a chain of controlled rotation gates R6 – R8 with each gate utilizing the corresponding control qubit as described above. A Hadamard (H) gate is applied to qubit q₆, and the result is serially applied through a chain of controlled rotation gates R7 – R8 with each gate utilizing the corresponding control qubit as described above. A Hadamard (H) gate is applied to qubit q₇, and the result is serially applied through controlled rotation gate R8 with the gate utilizing the corresponding control qubit as described above. In addition, a Hadamard (H) gate is applied to qubit q₈ (without subsequent controlled rotation gates). The resulting qubits are swapped by swap gates 255 (e.g., qubits q₁ and q₈, qubits q₂ and q₇, qubits q₃ and q₆, and qubits q₄ and q₅ are swapped) and combined to produce the result.

The QFT circuit may be distributed among two or more quantum processing units (QPU) 125. In this case, some quantum gates may be considered non-local gates where the control qubits for these quantum gates reside on a different QPU than the target qubits, thereby requiring expensive entangled (EPR) pairs to operate the gates. Gates that have control and target qubits on the same QPU are considered local gates (without requiring EPR pairs to operate the gates). Example embodiments provide techniques to distribute and execute a QFT circuit among QPUs for distributed processing of the QFT with minimal EPR pair consumption and improved processing performance. At the culmination of the technique, the qubits are properly positioned (in reverse order) among the quantum processors to obviate swapping of the qubits at completion of the QFT circuit. The technique relies on teleportation of the qubits.

With continued reference to FIGS. 1 and 2, FIG. 3A illustrates a method 300 to partition and execute a QFT circuit on two QPUs, according to an example embodiment. The example embodiment provides a method to use n EPR pairs for a QFT(n) circuit, where n represents the number of qubits for the QFT circuit. The QFT(n) circuit is distributed to two QPUs 125. Each of the QPUs has (n/2) + 1 computational qubits. The QPUs are also equipped with a communication qubit. The technique can be generalized to the case when the QPUs have any quantity of communication or computation qubits allowing for parallelization.

Typically, a QFT reverses the order of qubits which requires swap gates to correct the order for subsequent computations. However, in the distributed approach of the example embodiment, as qubits are teleported between the QPUs and the corresponding gates required for the QFT circuit are applied (or performed or executed), the final qubit states emerge in the correct order (e.g., reverse order) without the need of additional swaps.

Initially, qubits are assigned to two quantum processors (e.g., QPU1 and QPU2) at operation 305. For example, in the case of a QFT circuit with n qubits, qubits 1 to n/2 may be assigned to QPU1 and qubits (n/2) + 1 to n may be assigned to QPU2.

The gates within QPU1 that have qubits on QPU1 are applied to those qubits at operation 310. For example, the Hadamard (H) gate of QPU1 is applied for an i-th qubit followed by controlled rotation gates of QPU1 with the i-th qubit as the target qubit and a j-th qubit (j > i)as the control qubit, where i represents the qubits in QPU1 (1 to n/2).

The qubits between QPU1 and QPU2 are transferred to apply remaining gates for the QFT. For example, the qubits of QPU2 (e.g., qubits (n/2) + 1 to n) are transferred to QPU 1, while qubits of QPU1 are transferred to QPU2 (e.g., qubits n/2 to 1).

Entanglement between communication qubits of QPU1 and QPU2 is generated and a resulting EPR pair is transferred to the computational qubits at operation 315. A j-th qubit of QPU2 (j in (n/2) + 1 to n) is teleported to the computational qubit of QPU1 at operation 320. Controlled rotation gates of QPU1 between target qubits 1 and n – j + 1 of QPU1 with the j-th qubit of QPU2 being the control qubit are applied at operation 325.

Entanglement between communication qubits of QPU1 and QPU2 is generated and a resulting EPR pair is transferred to the computational qubits at operation 330. A qubit of QPU1 (qubit n – j + 1) is teleported to the computational qubit of QPU2. Controlled rotation gates of QPU2 between target qubit n – j + 1 from QPU1 and control qubits j + 1 to n of QPU2 are applied at operation 335.

The above process repeats from operation 315 until the qubits have been transferred and processed as determined at operation 340.

Once the qubits have been processed, the Hadamard (H) gate of QPU2 is applied for an i-th qubit followed by controlled rotation gates of QPU2 with the i-th qubit as the target qubit and a j-th qubit (j ≥ i) as the control qubit, where i represents the qubits in QPU2 ((n/2) + 1 to n). The order of the qubits is inherently reversed to provide a proper arrangement of the qubits for the QFT and avoid swapping.

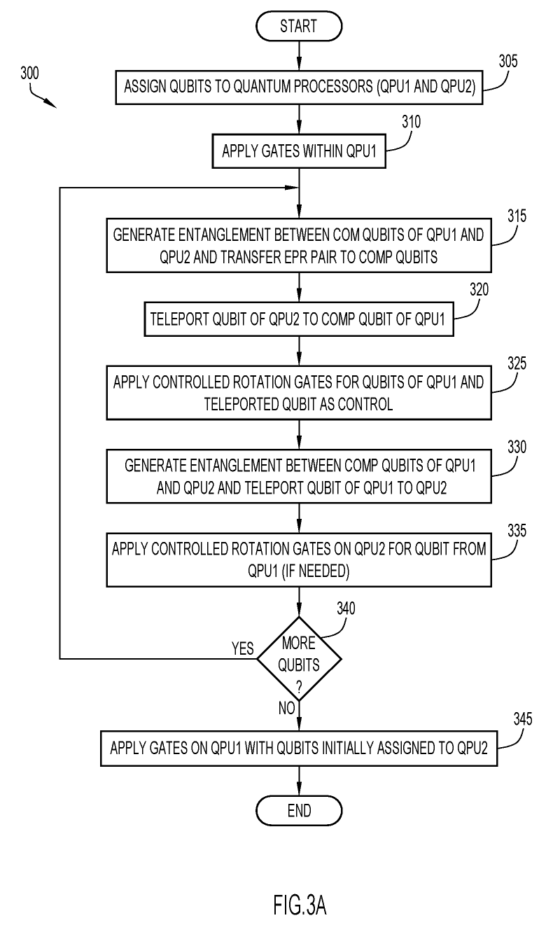

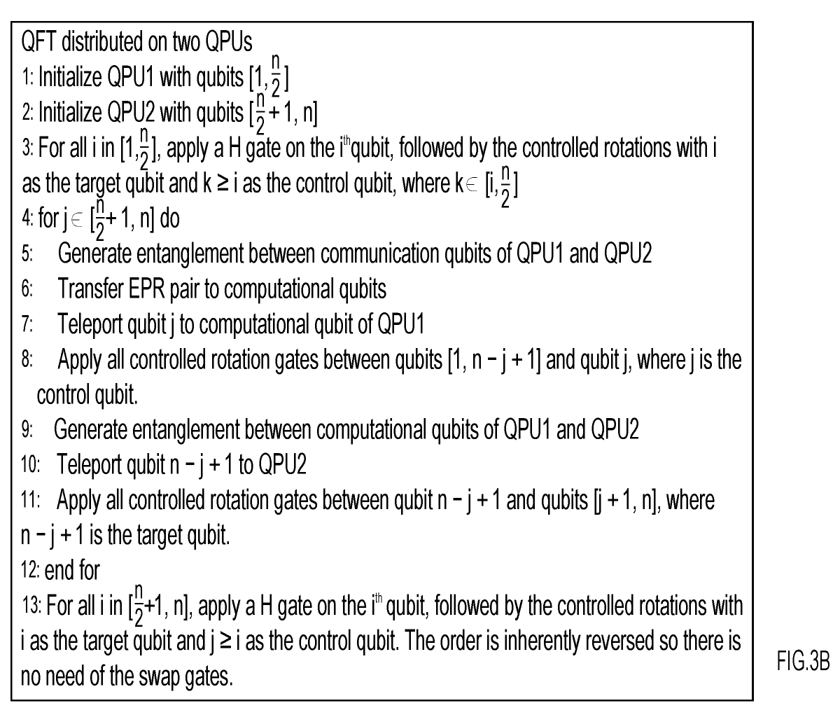

Example pseudocode corresponding to method 300 of FIG. 3A is illustrated in FIG. 3B.

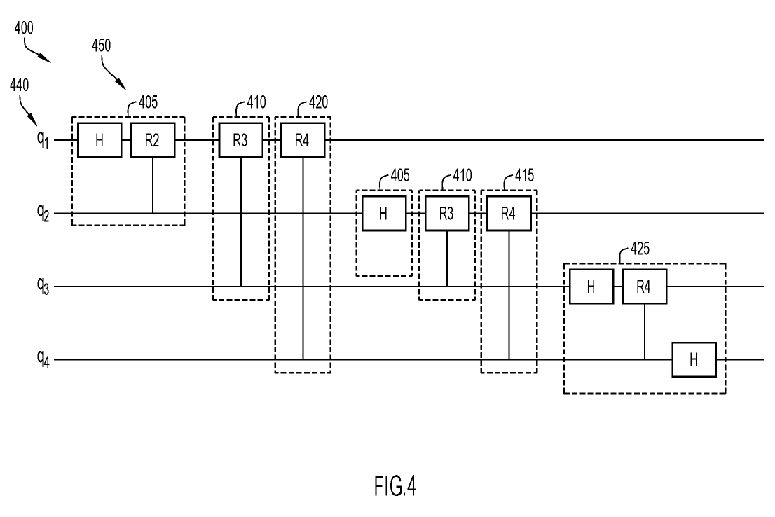

With continued reference to FIGS. 1, 2, 3A, and 3B, FIG. 4 illustrates an example of partitioning and executing an example QFT circuit among two quantum processors, according to an example embodiment. By way of example, QFT circuit 400 includes four qubits 440 (e.g., q₁, q₂, q₃, and q₄ as shown FIG. 4) and a series of quantum gates 450 (e.g., Hadamard (H) gates, controlled rotation gates (R2, R3, and R4), etc.) substantially similar to the quantum gates and arrangement described above. QFT circuit 400 is distributed among two QPUs 125 (QPU1 and QPU2) that each may implement the series of quantum gates.

Initially, the qubits are initialized and assigned to QPU1 and QPU2, where QPU1 contains qubits q₁ and q₂ and QPU2 contains qubits q₃ and q₄. The gates of QPU1 utilizing target and control qubits on QPU1 (e.g., H for qubits q₁ and q₂ and R2) are applied at operation 405.

Qubit q₃ is teleported from QPU2 to QPU1. Accordingly, QPU1 contains qubits q₁, q₂, and q₃, while QPU2 contains qubit q₄. The gate of QPU1 (R3) having qubit q₃ as a control qubit is applied at operation 410.

Qubit q₂ is teleported from QPU1 to QPU2. Accordingly, QPU1 contains qubits q₁ and q₃, while QPU2 contains qubits q₂ and q₄. The gate of QPU2 (R4) having qubit q₄ as a control qubit and qubit q₂ as a target qubit is applied at operation 415. Operations 410, 415 correspond to an initial iteration of operations 315 – 335 of method 300 (FIG. 3A) for a first qubit (e.g., and to an initial iteration of the for loop (line 4) of FIG. 3B).

Qubit q₄ is teleported from QPU2 to QPU1. Accordingly, QPU1 contains qubits q₁, q₃, and q₄, while QPU2 contains qubit q₂. The gate of QPU1 (R4) having qubit q₄ as a control qubit and qubit q₁ as a target qubit is applied at operation 420. Operation 420 corresponds to a second iteration of operations 315 – 335 of method 300 (FIG. 3A) for a second qubit (e.g., and to a second iteration of the for loop (line 4) of FIG. 3B).

Qubit q₁ is teleported from QPU1 to QPU2. Accordingly, QPU1 contains qubits q₃ and q₄, while QPU2 contains qubits q₁ and q₂. The gates of QPU2 (H for qubits q₃ and q₄ and R4) are applied at operation 425. Operation 425 corresponds to operation 345 of method 300 (FIG. 3A) (e.g., and the for loop (line 13) of FIG. 3B).

Since the QPUs contain qubits in the proper order (e.g., reverse order) needed for the QFT, no swapping of qubits is needed to obtain the result.

With continued reference to FIGS. 1, 2, 3A, 3B, and 4, FIG. 5A illustrates a method 500 for partitioning and executing a QFT circuit among three or more quantum processors, according to an example embodiment. The example embodiment provides a method to use a reduced amount of EPR pairs for a QFT(n), where n represents the number of qubits for the QFT circuit. The QFT(n) circuit is distributed to three or more QPUs 125. The qubits are divided into blocks with each QPU including k qubits (or k = n/m, where k represents the number of qubits per QPU, n represents the number of qubits for the QFT circuit, and m represents the number of QPUs). The QPUs may have any quantity of communication or computation qubits, and may allow for parallelization.

Typically, a QFT reverses the order of qubits which requires swap gates to correct the order for subsequent computations. However, in the distributed approach of the example embodiment, as qubits are teleported between the QPUs and the corresponding gates required for the QFT circuit are applied (or performed or executed), the final qubit states emerge in the correct order (e.g., reverse order) without the need of additional swaps.

Initially, qubits are assigned in blocks to the QPUs at operation 505. For example, in the case of a QFT circuit with n qubits to be distributed among m QPUs, the n qubits are divided into m blocks with each QPU handling a block of k qubits, where k = n/m.

Once the qubits are assigned to QPUs, the example embodiment proceeds in phases. In a first phase, for each QPU from i = 1 to m/2, the qubits are systematically moved between QPUs, and the necessary controlled rotation gates are applied. Specifically, for each qubit j in a block handled by QPU i, the qubit is moved successively through a series of QPUs i → i − 1 → i − 2 . . . → 1 → i + 1 → i + 2 . . . → n − i + 1 with controlled rotation gates applied from all the qubits in QPUs i, i − 1, i − 2 . . . 1, i + 1, i + 2 . . . n − i + 1 as control qubits and the j-th qubit as the target qubit. During this phase, another qubit l is selected from the original qubits of QPU n − i + 1 and moved to the i-th QPU.

Accordingly, a QPU is selected and the gates within the QPU that have qubits on the QPU are applied to those qubits at operation 510. For example, the Hadamard (H) gate of the QPU is applied for a j-th qubit followed by controlled rotation gates of the QPU with the j-th qubit as the target qubit and a p-th qubit (j < p ≤ k) as the control qubit, where j represents the qubits in the QPU (qubits 0 to k - 1).

A qubit of the block of the selected QPU is moved to the other QPUs at operation 515. Entanglement between communication qubits of QPUs is generated and resulting EPR pairs are transferred to computational qubits. For example, the qubit of a selected QPU i (from 1 to m/2) is teleported or moved successively through a series of QPUs i → i − 1 → i − 2 . . . → 1 → i + 1 → i + 2 . . . → n − i + 1. Controlled rotation gates with the teleported qubit as the target qubit are applied in QPUs i − 1 → i − 2 . . . → 1 → i + 1 → i + 2 . . . → m − i + 1 with qubits of those QPUs as the control qubits at operation 520.

An original qubit from a block of a QPU is selected at operation 525 and moved or teleported to the selected QPU at operation 530. A controlled rotation gate of the selected QPU is applied with the teleported qubit as the control qubit at operation 535. For example, a qubit r is selected from original qubits in block or QPU m − i + 1 and moved to the selected QPU i. A controlled rotation gate with qubit r as a control qubit is applied in selected QPU i.

The above process repeats from operation 515 until the qubits of the selected QPU have been transferred and processed as determined at operation 540.

Once the qubits of the selected QPU are processed, the above process repeats from operation 510 with qubits from a next QPU until the QPUs have been processed as determined at operation 545.

Once the QPUs have been processed, a second phase is performed. In the second phase, for each QPU i from m/2 to 1, a similar process is followed but in reverse order. Qubits are moved or teleported back through the QPUs i → i − 1 → i − 2 . . . → 1 → i with controlled rotation gates applied from each qubit in the QPUs i − 1, i − 2 . . . , 1 as the control qubit. A cat-entangler and cat-disentangler mechanism may also be utilized.

Accordingly, a QPU is selected and the gates within the QPU that have qubits on the QPU are applied to those qubits at operation 550. For example, the Hadamard (H) gate of the QPU is applied for a j-th qubit followed by controlled rotation gates of the QPU with the j-th qubit as the target qubit and a p-th qubit (j < p ≤ k) as the control qubit, where j represents the qubits in the QPU (qubits 0 to k - 1).

A qubit of the block of the selected QPU is moved or teleported to the other QPUs at operation 555. Entanglement between communication qubits of QPUs is generated and resulting EPR pairs are transferred to computational qubits. For example, the qubit of a selected QPU i (from m/2 to 1) is teleported or moved successively through a series of QPUs i → i − 1 → i − 2 . . . → 1 → i. Controlled rotation gates with the teleported qubit as the target qubit are applied in QPUs i − 1 → i − 2 → i - 3 . . . → i with qubits of those QPUs as the control qubits at operation 560.

The above process repeats from operation 555 until the qubits of the selected QPU have been transferred and processed as determined at operation 565.

Once the qubits of the selected QPU are processed, the above process repeats from operation 550 with qubits from a next QPU until the QPUs have been processed as determined at operation 570.

The example embodiment ensures that the QFT circuit is executed efficiently across the distributed quantum system, maintaining the correct qubit order (e.g., reverse order) required by a QFT without swap operations for the qubits.

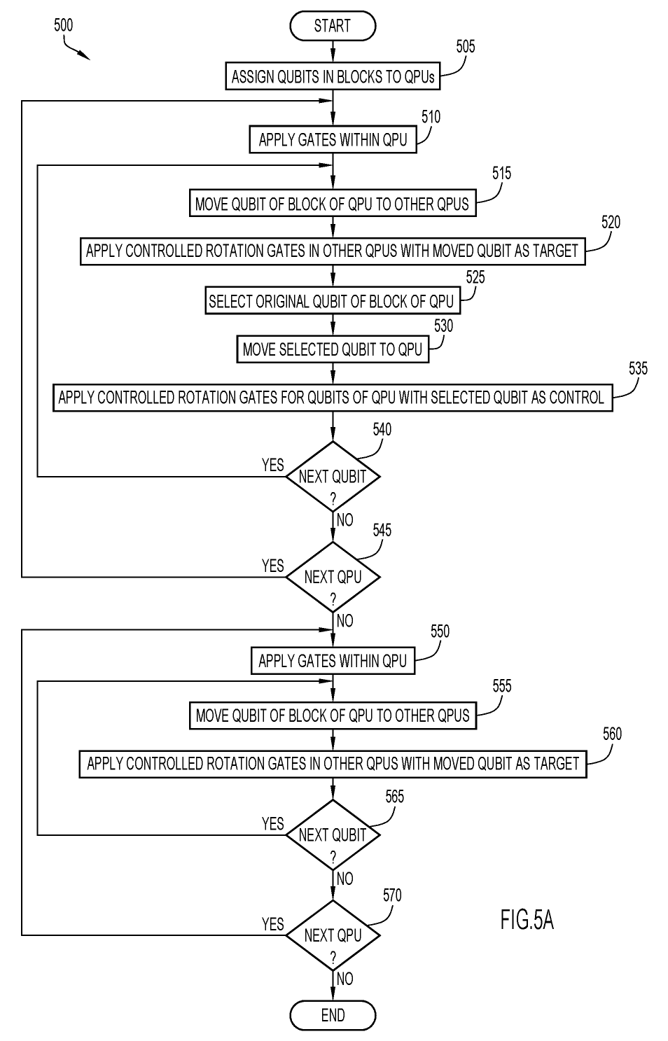

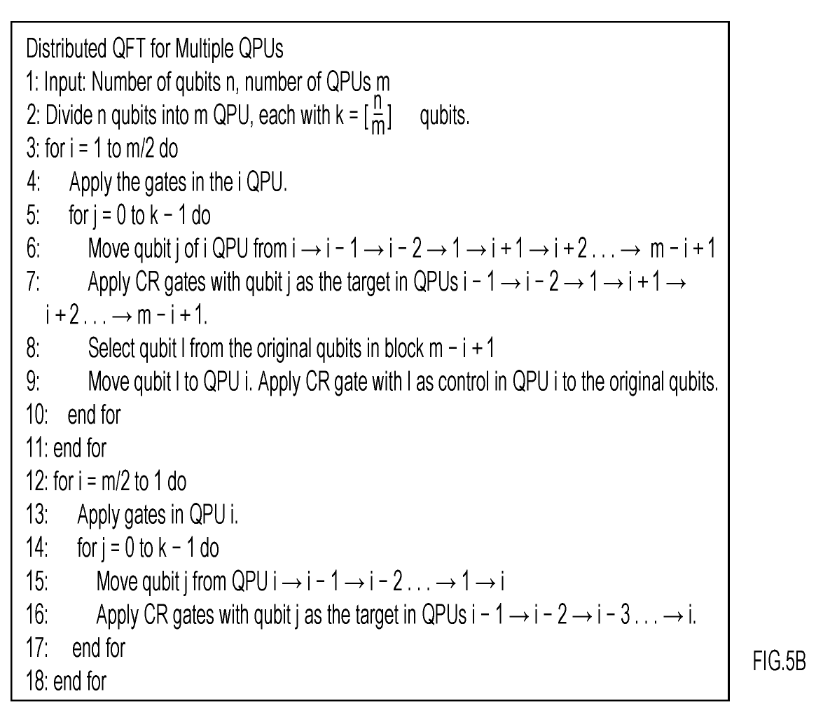

Example pseudocode corresponding to method 500 of FIG. 5A according to an example embodiment is illustrated in FIG. 5B.

The total number of EPR pairs required by the example embodiment for three or more QPUs is determined by considering the movement and interaction of qubits across QPUs.

For the first phase, the quantity of EPR pairs may be calculated as:

Total EPR pairs for the first phase ≤ k Σ (m + 1 - i), for i = 1 to m/2, where m is the number of QPUs, n is the number of qubits for the QFT, and k is the number of qubits per QPU (k = n/m).

When a cat-entangler and cat-disentangler mechanism is used for the second phase, the EPR pairs may be calculated as:

Total EPR pairs second phase ≤ k Σ (i - 1), for i = 1 to m/2, where m is the number of QPUs, n is the number of qubits for the QFT, and k is the number of qubits per QPU (k = n/m).

The total EPR pairs may be calculated as the sum of the first and second phases:

Total EPR pairs ≤ km²/2, where m is the number of QPUs, n is the number of qubits for the QFT, and k is the number of qubits per QPU (k = n/m).

The inequality in the above equation is due to the number of qubits in each QPU being upper bounded by k.

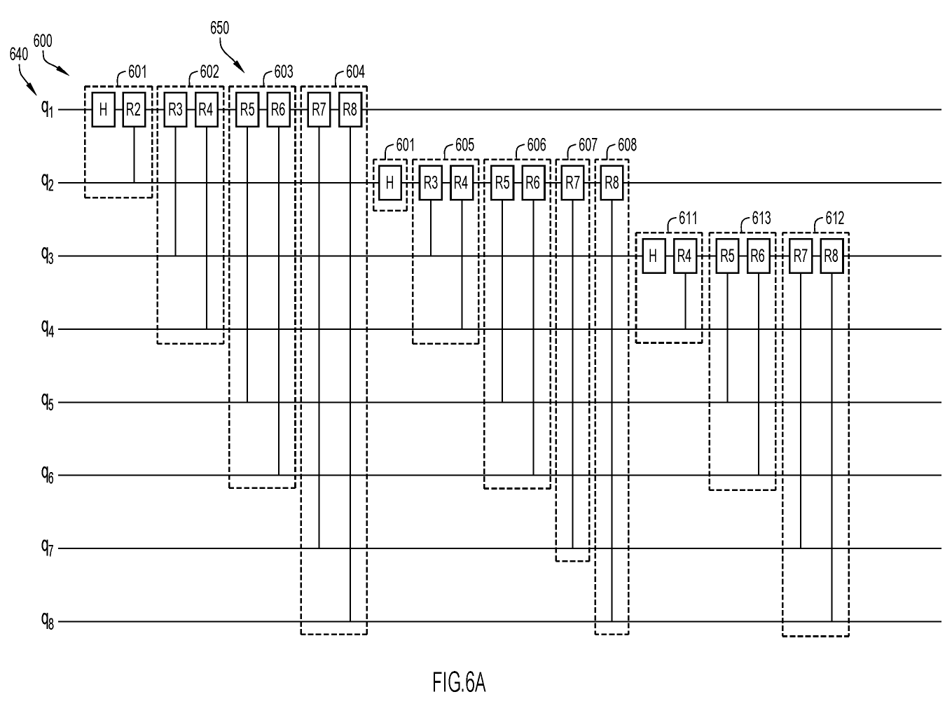

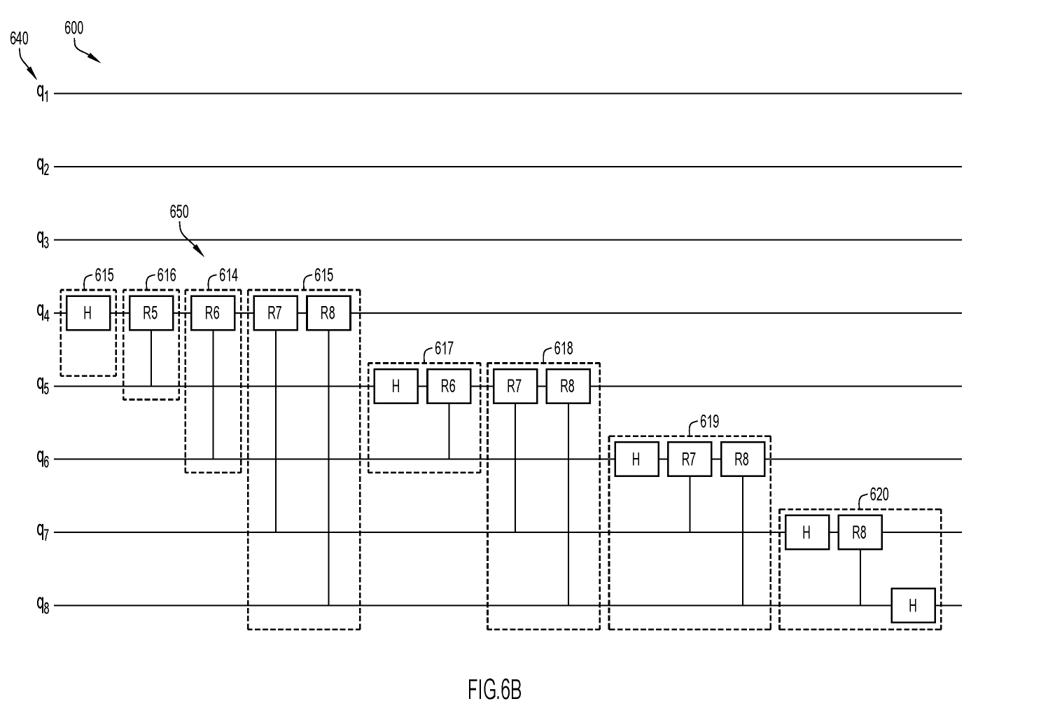

With continued reference to FIGS. 1, 2, 3A, 3B, 4, 5A, and 5B, FIGS. 6A - 6B illustrate an example of partitioning and executing an example QFT circuit among four quantum processors, according to an example embodiment. By way of example, QFT circuit 600 includes eight qubits 640 (e.g., q₁, q₂, q₃, q₄, q₅, q₆, q₇, and q₈ as shown FIGS. 6A - 6B and a series of quantum gates 650 (e.g., Hadamard (H) gates, controlled rotation gates (R2 – R8), etc.) substantially similar to the quantum gates and arrangement described above. QFT circuit 600 is distributed among four QPUs 125 (QPU1, QPU2, QPU3, and QPU4) that each may implement the series of quantum gates.

Initially, the qubits are initialized and assigned to QPU1, QPU2, QPU3, and QPU4, where QPU1 contains qubits q₁ and q₂, QPU2 contains qubits q₃ and q₄, QPU3 contains qubits q₅ and q₆, and QPU4 contains qubits q₇ and q₈. The gates of QPU1 utilizing target and control qubits on QPU1 (e.g., H for qubits q₁ and q₂ and R2) are applied at operation 601.

Qubit q₁ of QPU1 is teleported from QPU1 to QPU2. Accordingly, QPU1 contains qubit q₂, while QPU2 contains qubits q₁, q₃, and q₄. QPU3 and QPU4 contain their original qubits. The gates of QPU2 (R3 and R4) having teleported qubit q₁ as the target qubit and qubits q₃ and q₄ as the control qubits are applied at operation 602.

Qubit q₁ of QPU1 is teleported from QPU2 to QPU3. Accordingly, QPU1 contains qubit q₂, QPU2 contains qubits q₃ and q₄, and QPU3 contains qubits q₁, q₅, and q₆. QPU4 contains its original qubits. The gates of QPU3 (R5 and R6) having teleported qubit q₁ as the target qubit and qubits q₅ and q₆ as the control qubits are applied at operation 603.

Qubit q₁ of QPU3 is teleported from QPU3 to QPU4. Accordingly, QPU1 contains qubit q₂, QPU2 contains qubits q₃ and q₄, QPU3 contains qubits q₅ and q₆, and QPU4 contains qubits q₁, q₇, and q₈. The gates of QPU4 (R7 and R8) having teleported qubit q₁ as the target qubit and qubits q₇ and q₈ as the control qubits are applied at operation 604.

A qubit is selected from QPU4 and teleported to QPU1. By way of example, qubit q₈ may be selected and teleported to QPU1. Accordingly, QPU1 contains qubits q₂ and q₈, QPU2 contains qubits q₃ and q₄, QPU3 contains qubits q₅ and q₆, and QPU4 contains qubits q₁ and q₇. The gate of QPU1 (R8) having teleported qubit q₁ as the target qubit and qubit q₈ as the control qubit is applied at operation 608. Operations 602, 603, 604, and 608 correspond to an initial iteration of operations 515 – 535 of method 500 (FIG. 5A) for a first qubit (e.g., and to an initial iteration of the for loop (line 5) of FIG. 5B).

Qubit q₂ of QPU1 is teleported from QPU1 to QPU2. Accordingly, QPU1 contains qubit q₈, QPU2 contains qubits q₂, q₃, and q₄, QPU3 contains qubits q₅ and q₆, and QPU4 contains qubits q₁ and q₇. The gates of QPU2 (R3 and R4) having teleported qubit q₂ as the target qubit and qubits q₃ and q₄ as the control qubits are applied at operation 605.

Qubit q₂ of QPU2 is teleported from QPU2 to QPU3. Accordingly, QPU1 contains qubit q₈, QPU2 contains qubits q₃ and q₄, QPU3 contains qubits q₂, q₅, and q₆, and QPU4 contains qubits q₁ and q₇. The gates of QPU3 (R5 and R6) having teleported qubit q₂ as the target qubit and qubits q₅ and q₆ as the control qubits are applied at operation 606.

Qubit q₂ of QPU3 is teleported from QPU3 to QPU4. Accordingly, QPU1 contains qubit q₈, QPU2 contains qubits q₃ and q₄, QPU3 contains qubits q₅ and q₆, and QPU4 contains qubits q₁, q₂, and q₇. The gate of QPU4 (R7) having teleported qubit q₂ as the target qubit and qubit q₇ as the control qubit is applied at operation 607.

Qubit q₇ of QPU4 is teleported from QPU4 to QPU1. Accordingly, QPU1 contains qubits q₇ and q₈, QPU2 contains qubits q₃ and q₄, QPU3 contains qubits q₅ and q₆, and QPU4 contains qubits q₁ and q₂. The gates of QPU2 (H for qubit q₃ and R4) for qubits q₃ and q₄ are applied at operation 611. Operations 605, 606, 607, and 611 correspond to a second iteration of operations 515 – 535 of method 500 (FIG. 5A) for a second qubit (e.g., and to a second iteration of the for loop (line 5) of FIG. 5B).

Operations 602 – 608 and 611 correspond to an initial iteration of operations 510 – 535 of method 500 (FIG. 5A) for a first QPU (e.g., and to an initial iteration of the for loop (line 3) of FIG. 5B).

Qubit q₃ of QPU2 is teleported from QPU2 to QPU1. Accordingly, QPU1 contains qubits q₃, q₇ and q₈, QPU2 contains qubit q₄, QPU3 contains qubits q₅ and q₆, and QPU4 contains qubits q₁ and q₂. The gates of QPU1 (R7 and R8) having teleported qubit q₃ as the target qubit and qubits q₇ and q₈ as the control qubits are applied at operation 612.

Qubit q₃ of QPU1 is teleported from QPU1 to QPU3. Accordingly, QPU1 contains qubits q₇ and q₈, QPU2 contains qubit q₄, QPU3 contains qubits q₃, q₅ and q₆, and QPU4 contains qubits q₁ and q₂. The gates of QPU3 (R5 and R6) having teleported qubit q₃ as the target qubit and qubits q₅ and q₆ as the control qubits are applied at operation 613.

Qubit q₆ of QPU3 is teleported from QPU3 to QPU2. Accordingly, QPU1 contains qubits q₇ and q₈, QPU2 contains qubit q₄ and q₆, QPU3 contains qubits q₃ and q₅, and QPU4 contains qubits q₁ and q₂. The gate of QPU2 (R6) having qubit q₄ as the target qubit and qubit q₆ as the control qubit is applied at operation 614 (FIG. 6B). Operations 612, 613, and 614 correspond to an initial iteration of operations 515 – 535 of method 500 (FIG. 5A) for a first qubit of a second QPU (e.g., and to an initial iteration of the for loop (line 5) of FIG. 5B).

Qubit q₄ of QPU2 is teleported from QPU2 to QPU1. Accordingly, QPU1 contains qubits q₄, q₇, and q₈, QPU2 contains qubit q₆, QPU3 contains qubits q₃ and q₅, and QPU4 contains qubits q₁ and q₂. The gates of QPU1 (R7 and R8) having teleported qubit q₄ as the target qubit and qubits q₇ and q₈ as the control qubits are applied at operation 615.

Qubit q₄ of QPU1 is teleported from QPU1 to QPU3. Accordingly, QPU1 contains qubits q₇ and q₈, QPU2 contains qubit q₆, QPU3 contains qubits q₃, q₄, and q₅, and QPU4 contains qubits q₁ and q₂. The gate of QPU3 (R5) having teleported qubit q₄ as the target qubit and qubit q₅ as the control qubit is applied at operation 616. Operations 615 and 616 correspond to a second iteration of operations 515 – 535 of method 500 (FIG. 5A) for a second qubit of a second QPU (e.g., and to a second iteration of the for loop (line 5) of FIG. 5B).

Operations 612 – 616 correspond to a second iteration of operations 510 – 535 of method 500 (FIG. 5A) for a second QPU (e.g., and to a second iteration of the for loop (line 3) of FIG. 5B).

Qubit q₅ of QPU3 is teleported from QPU3 to QPU2. Accordingly, QPU1 contains qubits q₇ and q₈, QPU2 contains qubit q₅ and q₆, QPU3 contains qubits q₃ and q₄, and QPU4 contains qubits q₁ and q₂. The gates of QPU2 (H for qubit q₅ and R6) having corresponding qubits on QPU2 are applied at operation 617.

Qubit q₅ of QPU2 is teleported from QPU2 to QPU1. Accordingly, QPU1 contains qubits q₅, q₇, and q₈, QPU2 contains qubit q₆, QPU3 contains qubits q₃ and q₄, and QPU4 contains qubits q₁ and q₂. The gates of QPU1 (R7 and R8) having teleported qubit q5 as the target qubit and qubits q₇ and q₈ as the control qubits are applied at operation 618.

Qubit q₅ of QPU1 is teleported from QPU1 back to QPU2. Accordingly, QPU1 contains qubits q₇, and q₈, QPU2 contains qubits q₅ and q₆, QPU3 contains qubits q₃ and q₄, and QPU4 contains qubits q₁ and q₂.

Qubit q₆ of QPU2 is teleported from QPU2 to QPU1. Accordingly, QPU1 contains qubits q₆, q₇, and q₈, QPU2 contains qubit q₅, QPU3 contains qubits q₃ and q₄, and QPU4 contains qubits q₁ and q₂. The gates of QPU1 (H for qubit q₆ and R7 and R8) corresponding to teleported qubit q₆ and qubits q₇ and q₈ are applied at operation 619.

Alternatively, a cat-entangler and cat-disentangler technique may be used to perform operations 618 and 619.

Qubit q₆ of QPU1 is teleported from QPU1 back to QPU2. Accordingly, QPU1 contains qubits q₇, and q₈, QPU2 contains qubits q₅ and q₆, QPU3 contains qubits q₃ and q₄, and QPU4 contains qubits q₁ and q₂. The gates of QPU1 (H for qubits q₇ and q₈ and R8) having the corresponding qubits on QPU1 are applied at operation 620. Operations 617 – 620 correspond to operations 550 – 570 of method 500 (FIG. 5A) (e.g., and to the for loop (line 14) of FIG. 5B).

Since the QPUs contain qubits in the proper order (e.g., reverse order) needed for the QFT, no swapping of qubits is needed to obtain the result.

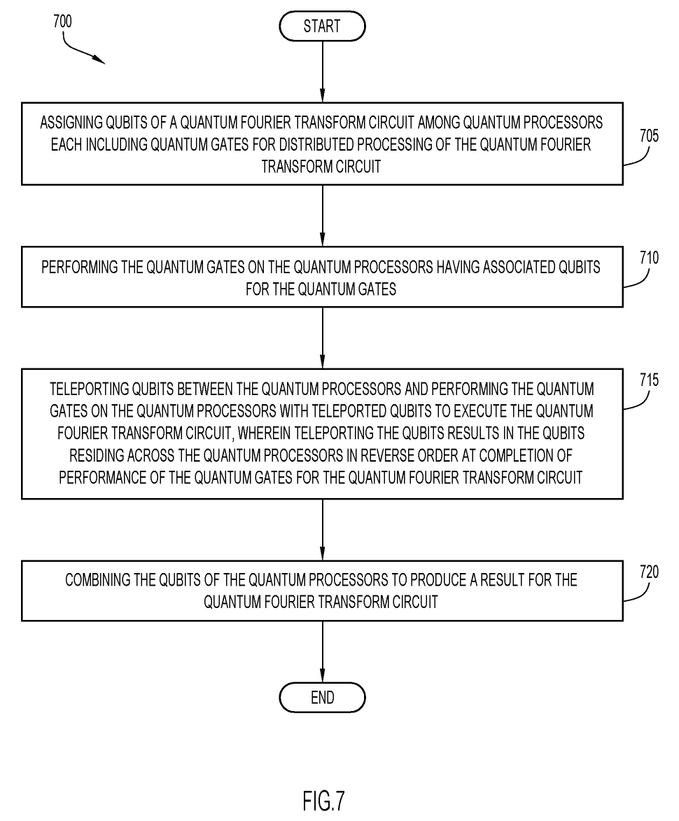

FIG. 7 illustrates an example method 700 for partitioning and executing a QFT circuit for distributed quantum processing, according to an example embodiment. At operation 705, qubits of a quantum Fourier transform circuit are assigned among quantum processors each including quantum gates for distributed processing of the quantum Fourier transform circuit. At operation 710, the quantum gates are performed on the quantum processors having associated qubits for the quantum gates. At operation 715, qubits are teleported between the quantum processors and the quantum gates are performed on the quantum processors with teleported qubits to execute the quantum Fourier transform circuit. Teleporting the qubits results in the qubits residing across the quantum processors in reverse order at completion of performance of the quantum gates for the quantum Fourier transform circuit. At operation 720, the qubits of the quantum processors are combined to produce a result for the quantum Fourier transform circuit.

The example embodiments described above control the switch configurations as well as the actions taken by memory and communication qubits. Depending on the EPR requirement between each QPU, the location in the datacenter is determined for initializing the corresponding QPU. Thus, a central control decides the exact schedule for the network components. In other words, timing of functions of network components is assigned based on timing of performance of the quantum gates and teleportation of the quantum processors.

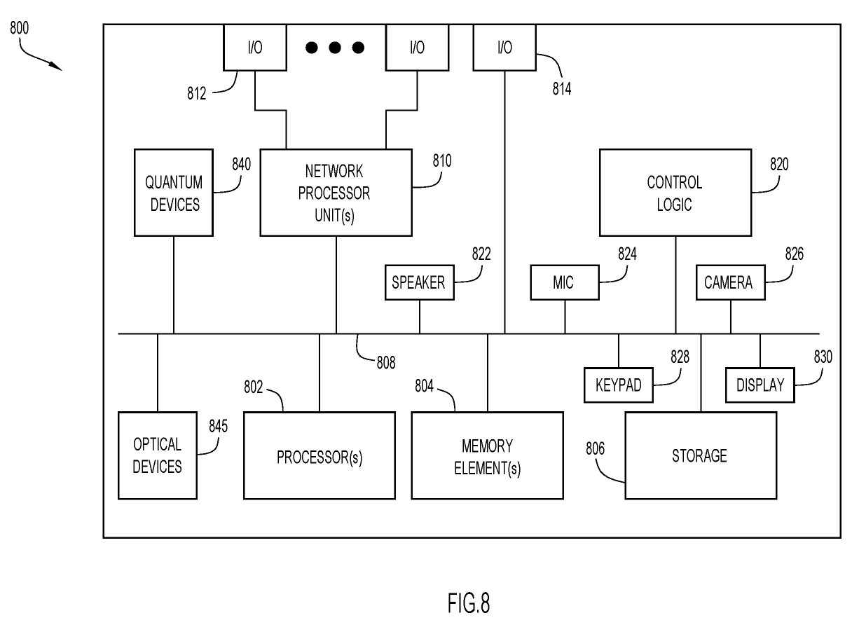

Referring to FIG. 8, FIG. 8 illustrates a hardware block diagram of a computing device 800 that may perform functions associated with operations discussed herein in connection with the techniques depicted in FIGS. 1, 2, 3A, 3B, 4, 5A, 5B, 6A, 6B, and 7. In various embodiments, a computing device or apparatus or system, such as computing device 800 or any combination of computing devices 800, may be configured as any device entity/entities (e.g., network nodes, computer devices, user devices, client devices, communication devices, network devices, processors, switching devices, network interfaces, quantum nodes, etc.) as discussed for the techniques depicted in connection with FIGS. 1, 2, 3A, 3B, 4, 5A, 5B, 6A, 6B, and 7 in order to perform operations of the various techniques discussed herein.

In at least one embodiment, computing device 800 may be any apparatus that may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory elements 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interfaces 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, network device, network nodes, processors, network interfaces, switching devices, quantum nodes, etc.), computing device 800 may further include, or be coupled to, a speaker 822 to convey sound, microphone or other sound sensing device 824, camera or image capture device 826, a keypad or keyboard 828 to enter information (e.g., alphanumeric information, etc.), a touch screen or other display 830, quantum devices 840, and/or optical devices 845. These items may be coupled to bus 808 or I/O interface(s) 814 to transfer data with other elements of computing device 800. Quantum devices 840 may include any conventional or other devices to perform the functions described herein (e.g., generating, transmitting, receiving, entangling, and/or processing quantum signals and/or keys), such as a quantum source, quantum transmitters and receivers, quantum channels, a source of randomness, lasers or other energy sources, quantum measuring devices, quantum logic or other gates or circuits, quantum memories, quantum processors, quantum buffers, quantum switches, etc. Optical devices 845 may include any conventional or other optical devices to perform the functions described herein (e.g., generating, transmitting, receiving, and/or processing classical or other optical signals), such as optical switches, optical transmitters and receivers, optical multiplexers or other switching devices, etc.

In various embodiments, control logic 820 can include instructions that, when executed, cause processor(s) 802 to perform operations, which can include, but not be limited to, providing overall control operations of computing device 800; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more device entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory elements 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combinations of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: assigning qubits of a quantum Fourier transform circuit among quantum processors each including quantum gates for distributed processing of the quantum Fourier transform circuit; performing the quantum gates on the quantum processors having associated qubits for the quantum gates; teleporting qubits between the quantum processors and performing the quantum gates on the quantum processors with teleported qubits to execute the quantum Fourier transform circuit, wherein teleporting the qubits results in the qubits residing across the quantum processors in reverse order at completion of performance of the quantum gates for the quantum Fourier transform circuit; and combining the qubits of the quantum processors to produce a result for the quantum Fourier transform circuit.

In one example, assigning qubits comprises assigning the qubits among two quantum processors each with half a number of qubits for the quantum Fourier transform circuit.

In one example, performing the quantum gates on the quantum processors with teleported qubits comprises performing the quantum gates on a second quantum processor with a teleported qubit from a first quantum processor as a control qubit.

In one example, assigning qubits comprises assigning the qubits among three or more quantum processors each with a number of qubits for the quantum Fourier transform circuit divided by a number of quantum processors.

In one example, teleporting qubits comprises teleporting a qubit from a first quantum processor successively through other quantum processors of the three or more quantum processors.

In one example, performing the quantum gates on the quantum processors with teleported qubits comprises performing the quantum gates on the other quantum processors with a teleported qubit as a target qubit.

In one example, the method further comprises assigning timing of functions of network components based on timing of performance of the quantum gates and teleportation of the quantum processors.

In another form, an apparatus is provided. The apparatus comprises a network interface; memory; and at least one processor configured to perform operations including: assigning qubits of a quantum Fourier transform circuit among quantum processors each including quantum gates for distributed processing of the quantum Fourier transform circuit; performing the quantum gates on the quantum processors having associated qubits for the quantum gates; teleporting qubits between the quantum processors and performing the quantum gates on the quantum processors with teleported qubits to execute the quantum Fourier transform circuit, wherein teleporting the qubits results in the qubits residing across the quantum processors in reverse order at completion of performance of the quantum gates for the quantum Fourier transform circuit; and combining the qubits of the quantum processors to produce a result for the quantum Fourier transform circuit

In another form, an apparatus is provided. The apparatus comprises a plurality of quantum processors each including qubits and quantum gates for distributed processing of a quantum Fourier transform circuit, wherein the plurality of quantum processors is configured to perform operation including: performing the quantum gates on the plurality of quantum processors having associated qubits for the quantum gates; teleporting qubits between the plurality of quantum processors and performing the quantum gates on the plurality of quantum processors with teleported qubits to execute the quantum Fourier transform circuit, wherein teleporting the qubits results in the qubits residing across the plurality of quantum processors in reverse order at completion of performance of the quantum gates for the quantum Fourier transform circuit; and combining the qubits of the plurality of quantum processors to produce a result for the quantum Fourier transform circuit.

The description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
assigning qubits of a quantum Fourier transform circuit among quantum processors each including quantum gates for distributed processing of the quantum Fourier transform circuit;
performing the quantum gates on the quantum processors having associated qubits for the quantum gates;
teleporting qubits between the quantum processors and performing the quantum gates on the quantum processors with teleported qubits to execute the quantum Fourier transform circuit, wherein teleporting the qubits results in the qubits residing across the quantum processors in reverse order at completion of performance of the quantum gates for the quantum Fourier transform circuit; and
combining the qubits of the quantum processors to produce a result for the quantum Fourier transform circuit.

2. The method of claim 1, wherein assigning qubits comprises:
assigning the qubits among two quantum processors each with half a number of qubits for the quantum Fourier transform circuit.

3. The method of claim 2, wherein performing the quantum gates on the quantum processors with teleported qubits comprises:
performing the quantum gates on a second quantum processor with a teleported qubit from a first quantum processor as a control qubit.

4. The method of claim 1, wherein assigning qubits comprises:
assigning the qubits among three or more quantum processors each with a number of qubits for the quantum Fourier transform circuit divided by a number of quantum processors.

5. The method of claim 4, wherein teleporting qubits comprises:
teleporting a qubit from a first quantum processor successively through other quantum processors of the three or more quantum processors.

6. The method of claim 5, wherein performing the quantum gates on the quantum processors with teleported qubits comprises:
performing the quantum gates on the other quantum processors with a teleported qubit as a target qubit.

7. The method of claim 1, further comprising:
assigning timing of functions of network components based on timing of performance of the quantum gates and teleportation of the quantum processors.

8. An apparatus comprising:
a network interface;
memory; and
at least one processor configured to perform operations including:
assigning qubits of a quantum Fourier transform circuit among quantum processors each including quantum gates for distributed processing of the quantum Fourier transform circuit;
performing the quantum gates on the quantum processors having associated qubits for the quantum gates;
teleporting qubits between the quantum processors and performing the quantum gates on the quantum processors with teleported qubits to execute the quantum Fourier transform circuit, wherein teleporting the qubits results in the qubits residing across the quantum processors in reverse order at completion of performance of the quantum gates for the quantum Fourier transform circuit; and
combining the qubits of the quantum processors to produce a result for the quantum Fourier transform circuit.

9. The apparatus of claim 8, wherein assigning qubits comprises:
assigning the qubits among two quantum processors each with half a number of qubits for the quantum Fourier transform circuit.

10. The apparatus of claim 9, wherein performing the quantum gates on the quantum processors with teleported qubits comprises:
performing the quantum gates on a second quantum processor with a teleported qubit from a first quantum processor as a control qubit.

11. The apparatus of claim 8, wherein assigning qubits comprises:
assigning the qubits among three or more quantum processors each with a number of qubits for the quantum Fourier transform circuit divided by a number of quantum processors.

12. The apparatus of claim 11, wherein teleporting qubits comprises:
teleporting a qubit from a first quantum processor successively through other quantum processors of the three or more quantum processors; and
performing the quantum gates on the other quantum processors with a teleported qubit as a target qubit.

13. The apparatus of claim 8, wherein the at least one processor is further configured to perform operations including:
assigning timing of functions of network components based on timing of performance of the quantum gates and teleportation of the quantum processors.

14. An apparatus comprising:
a plurality of quantum processors each including qubits and quantum gates for distributed processing of a quantum Fourier transform circuit, wherein the plurality of quantum processors is configured to perform operations including:
performing the quantum gates on the plurality of quantum processors having associated qubits for the quantum gates;
teleporting qubits between the plurality of quantum processors and performing the quantum gates on the plurality of quantum processors with teleported qubits to execute the quantum Fourier transform circuit, wherein teleporting the qubits results in the qubits residing across the plurality of quantum processors in reverse order at completion of performance of the quantum gates for the quantum Fourier transform circuit; and
combining the qubits of the plurality of quantum processors to produce a result for the quantum Fourier transform circuit.

15. The apparatus of claim 14, wherein the qubits are assigned among two quantum processors each with half a number of qubits for the quantum Fourier transform circuit.

16. The apparatus of claim 15, wherein performing the quantum gates on the plurality of quantum processors with teleported qubits comprises:
performing the quantum gates on a second quantum processor with a teleported qubit from a first quantum processor as a control qubit.

17. The apparatus of claim 14, wherein the qubits are assigned among three or more quantum processors each with a number of qubits for the quantum Fourier transform circuit divided by a number of quantum processors.

18. The apparatus of claim 17, wherein teleporting qubits comprises:
teleporting a qubit from a first quantum processor successively through other quantum processors of the three or more quantum processors.

19. The apparatus of claim 18, wherein performing the quantum gates on the plurality of quantum processors with teleported qubits comprises:
performing the quantum gates on the other quantum processors with a teleported qubit as a target qubit.

20. The apparatus of claim 14, further comprising:
a controller configured to assign timing of functions of network components based on timing of performance of the quantum gates and teleportation of the plurality of quantum processors.
